(19) United States
(12) Patent Application Publication
(10) Pub. No.: US 2009/0018767 A1
(43) Pub. Date: Jan. 15, 2009

(54) METHOD FOR DETERMINING THE GEOMETRY OF A ROUTE SECTION

(75) Inventors: Ottmar Gehring, Kernen (DE); Frederic Holzmann, Neutraubling (DE); Sascha Paasche, Tokyo (JP); Andreas Schwarzhaupt, Landau (DE); Gernot Spiegelberg, Bad Abbach (DE); Armin Sulzmann, Heidelberg (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 11/915,796

(22) PCT Filed: May 20, 2006
(86) PCT No.: PCT/EP06/04800

§ 371 Date: Apr. 11, 2008

(30) Foreign Application Priority Data
May 28, 2005 (DE) 10 2005 024 558.7

(51) Int. Cl. G01C 21/34

(52) U.S. Cl. 701/202; 701/213

(57) ABSTRACT

A method for determining the geometry of a route section, using route points representing information about the route section, wherein route section data between at least three adjacent route point s are calculated, for determining a maximum possible speed for a vehicle traveling along the route section, is characterized in that a check is made to ascertain whether two adjacent route points f all below respectively predeterminable distances from one another and in the affirmative route section data through the se route points are calculated as a) straight line if the route points are arranged in a straight strip of predeterminable width, or b) arc of a circle if the route points are arranged in a constantly curved strip of predeterminable width and the tangent to the, in the direction of travel, first one of the route points is essentially located on a direction vector of the vehicle, or c) clothoid if the route points are arranged in a progressively curved strip of predeterminable width, wherein the geometry of the route section in the region of said route points is in each case determined in the form of the calculated route section data.

The invention relates to a method for determining the geometry of a route section in accordance with the preamble of claim 1.

In this case, the geometry is determined using route points, wherein the route points represent information about the route sections, for example about the geographical arrangement thereof. From the geometry determined, a maximum possible speed is then determined for a vehicle traveling along the route section, for example in a curve lying ahead.

A method of this type is known from U.S. Pat. No. 6,138,084. In that case, provision is made for providing an arc of a circle through in each case three route points. However, a problem arises here in the case of route points that are not exactly localized, since the arc of the circle does not then match the geometry of the actual route section.

An improvement is proposed in U.S. Pat. No. 6,343,253 B1. An individual, singular route point is treated separately for this purpose. In specific cases, this results in a somewhat better determination of the geometry of a route section. An improved method is known from U.S. Pat. No. 6,163,741. In that case, not only the number of route points on a curve but also the length of an arc of a circle or particular features of the curve such as a possible S-shape, for example, are taken into account. This results in an improved determination of the geometry of a route section, but relatively complicated calculations are required.

US 2004/0111209 proposes providing a limit speed per route section point. A maximum deceleration and/or a local end point of the deceleration can thus be determined for route section points. However, this improved procedure requires a complicated data collection and processing in that it is necessary to determine the limit speeds for the individual route points.

Proceeding from this known prior art, it emerges that the object of the invention is to specify a method which makes it possible to determine the geometry of a route section in a relatively simple and uncomplicated manner.

According to the invention, it is provided that a check is made to ascertain whether two adjacent route points fall below a respectively predeterminable distance from one another and in the affirmative route section data through the at least three adjacent route points are calculated as a) straight line if the route points are arranged in a straight strip of predeterminable width, or b) arc of a circle if the route points are arranged in a constantly curved strip of predeterminable width and the tangent to the, in the direction of travel, first one of the route points is essentially located on a direction vector of the vehicle, or c) clothoid if the route points are arranged in a progressively curved strip of predeterminable width, wherein the geometry of the route section in the region of the route points is in each case determined in the form of the calculated route section data. To put it another way, three hypotheses are made about the geometry of the route section and a check is made successively to ascertain which of the hypotheses is currently applicable. According to the official “guidelines for laying out roads”, (almost) all route sections can be assigned to precisely one of these three types. Consequently, a rapid and simple check is possible by checking for the existence of a straight line or arc of a circle or clothoid parameterized in accordance with the current route points.

The invention enables a relatively uncomplicated determination of the geometry of a route section lying ahead. Proceeding from at least three available route points, firstly the model of a straight line is calculated. For this purpose, a check is made to ascertain whether the available route points are arranged within a strip of predeterminable width. As long as this is the case, the route section is set as a straight line. If one or a plurality of route points are arranged outside the predeterminable width, the hypothetical consideration as a straight line is terminated and the equation of an arc of a circle is established, wherein the arc of the circle runs as well as possible through the available route points. For this purpose, in addition the tangent to the first route point as seen in the direction of travel must be essentially located on a (past, current or future direction vector of the vehicle, that is to say that no “sharp bend” is permitted to occur in the route. If this is not possible, the arc of a circle model is rejected in favor of the clothiod, which is adapted correspondingly.

This procedure according to the invention represents a relatively simple possibility for determining the route section geometry lying ahead. In this case, it enables comparatively accurate results since it correspondingly takes in account in each case the underlying type of a route section, namely a straight line, arc of a circle or clothoid. The respective hypothesis of fixing the route section as a straight line, arc of a circle or clothoid results in a relatively rapid decision as to which type of route section is to be fixed. Since these three basic models of a respective route section can easily be adapted by means of the respective parameters, a relatively accurate modeling of the route section results with little complexity.

Preferably, the route section data through the route points are calculated using the least error squares method, i.e. the check is carried out using the least error squares method. This enables a rapid decision for one of the three hypotheses according to the invention for determining the route section as a straight line or arc of a circle or clothoid. In this case, a straight line and arc of a circle and clothoid form as it were the “centroid line” of the route section data.

It has been found that preferably approximately two meters are fixed as predeterminable width for a strip in which the route points are arranged. Such a width is particularly suitable as approximate width of a lane.

In this case, the route points can be obtained as nodes and/or intermediate nodes (“shape points”) from a digital road map. Navigation systems, for example, include digital road maps and are readily available in a large number of modern vehicles. By virtue of such digital road maps being created by specialist companies, relatively accurate route points with information about the route sections are present in the nodes or intermediate nodes. If the current traveling route is known, a preview of the route sections traveled along with high likelihood is possible. However, only those route points which are contained in the digital road map are available, that is to say that it is not possible to obtain arbitrarily “fine” route points.

As an alternative or in addition, provision may be made for obtaining route points using a position determining means at the vehicle, in particular a GPS and/or GALILEO receiver. This is advantageous for example when the current traveling route is not known or if a (complete) digital road map is not available at the vehicle, e.g. in a toll collection device. Route points can thereby be obtained arbitrarily “finely” e.g. one route point every second.

A further possibility is obtaining route points with the use of an image acquisition and evaluation, in particular of a video system. In this case, the route points are obtained by means of a corresponding image evaluation e.g. of the video camera. The video camera can “see” the road directly and therefore obtain route points with information about route sections lying ahead. In this case, however, the video camera is locally restricted in that it only sees what a driver in the vehicle sees as well. In this case, the video camera can be provided in the vehicle itself or else be switched on via vehicle-vehicle communication from a vehicle traveling ahead. By this means, too, route points can be obtained arbitrarily “finely” e.g. one route point every second. Preferably, two or more of the methods for obtaining route points are combined with one another in order to obtain a precise result, for example by combining the “local” video camera and the “global” digital road map with one another. While the video camera can record the route points at arbitrary distances, digital maps are provided with nodes or intermediate nodes as route points at different, fixedly predetermined distances. A good complementation results in this respect. The current position of the vehicle is preferably obtained by a or the position determining means, for example GPS, Glonass or GALILEO.

In a particularly preferred embodiment of the invention, it is provided that for the case where a new route point is available, the geometry of the route section is retained when the distance between the new route point and the last route point falls below the respectively predeterminable distance and the new route point is arranged on the straight line or arc of a circle or clothoid determined by the at least three route points, otherwise a check is made to ascertain whether the new route point and also the last two route points in the direction of travel fall below respectively predeterminable distances from one another and in the affirmative route section data through the route points are calculated as a) straight line if the route points are arranged in a straight strip of predeterminable width, or b) arc of a circle if the route points are arranged in a constantly curved strip of predeterminable width and the tangent to the, in the direction of travel, first one of the route points is essentially located on a direction vector of the vehicle, or c) clothoid if the route points are arranged in a progressively curved strip of predeterminable width, wherein the geometry of the route section in the region of said route points is in each case determined in the form of the calculated route section data. By carrying out this procedure for each newly available route point, this results in a rapid adaptation to new route geometries. This iterative method ensures that each new route point is firstly checked in respect of whether it continues to fulfill the previous route geometries, and otherwise a check is made to ascertain which new type of route geometry selected from a straight line, arc of circle or clothoid is formed by the points. Such a procedure ensures a particularly rapid, simple and flexible determination of a route section lying ahead. As long as a new route section is located on the already known geometry, this geometry is continued. Otherwise the adapted new geometry is determined. This results in a continuous sequence of geometries of the route sections.

In one advantageous development of the particularly preferred embodiment, it is provided that, for the case where a new route point is available which exceeds the predeterminable distance, a straight line is assumed as route geometry. This takes account of the circumstance that in digital road maps straight lines are usually represented by route points lying far apart from one another, in order correspondingly to save memory space.

A further advantageous development of the particularly preferred embodiment, it is provided that, if a new route point is available which is arranged outside the strip of predeterminable width, a check is made to ascertain whether the new route point is part of an intersection. Such a check may for example encompass whether the geometry of the current route section was determined as a straight line or arc of circle or clothoid of slight curvature, or the activation of obtaining further route points in order to validate a decision. An intersection requires particular control interventions at the vehicle, for example the vehicle side setting of an intersection speed, and a rapid identification of an intersection is therefore necessary. Since such an intersection is preferably arranged on straight or slightly curved routes and comprises route points which are arranged near the route previously traveled along, this results in a simple identification of intersections in the road geometry. However, the geometry of the route section can possibly be retained despite the intersection.

Preferably, the speed of the vehicle is determined depending on the determined geometry of the route section in such a way that a linear change in speed to the maximum possible speed for the route section or intersection lying ahead is performed. A comfortable constant deceleration of the vehicle is realized with this linear change in speed. The speed profile determined in this way can then be used for the activation of a speed regulating system at the vehicle. As an alternative or in addition, provision is made, in the case where the current vehicle speed exceeds the determined speed, for performing visual, acoustic and/or haptic outputs to the driver of the vehicle. Furthermore, in specific cases, for example in the case of considerable exceeding of the speed, an automatic braking intervention can be provided at the vehicle. In this case, the maximum possible speed for a route section is preferably determined depending on the vehicle in order e.g. to take account of the differences between passenger automobiles and trucks. Thus, a maximum speed of 10 km/h can be provided for trucks in the region of the intersection. From the clothoid and arc of circle models it is possible to determine curve radii and thus, by means of the centrifugal force, a respective maximum permissible speed, such that the vehicle does not deviate from the route.

The invention will now be explained with reference to the drawings in which:

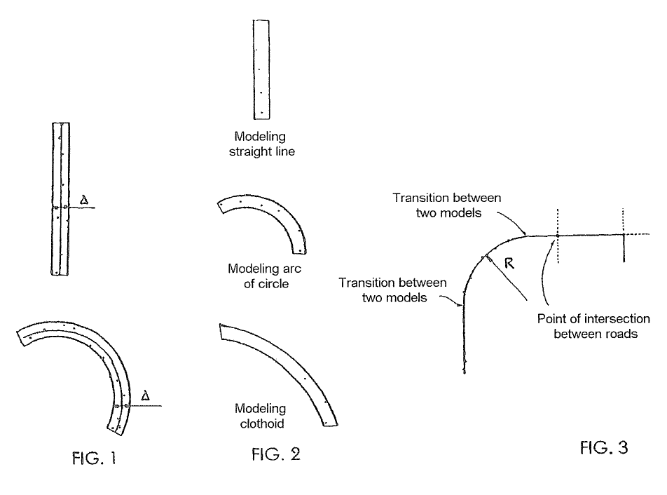

FIG. 1 shows by way of example route sections determined as a straight line and as an arc of a circle, with respective route points;

FIG. 2 shows by way of example a modeling of in each case three route points as a straight line, arc of circle, clothoid;

FIG. 3 shows by way of example a route as a combined sequence of different route sections;

FIG. 4 shows by way of example the deceleration model for different types of route sections; and

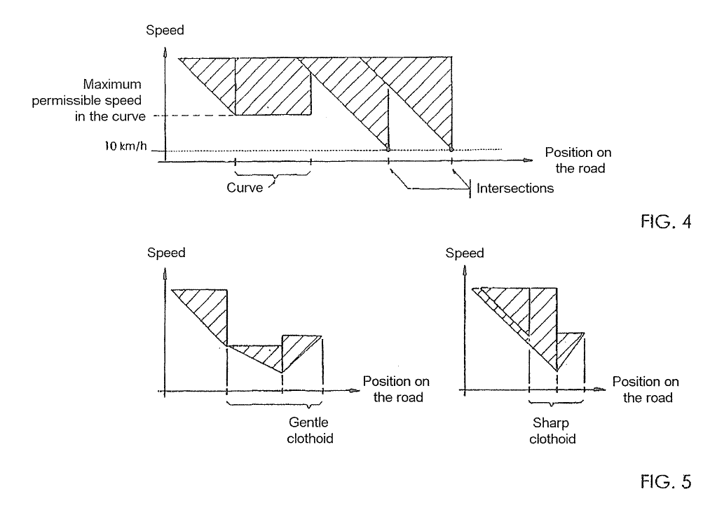

FIG. 5 shows by way of example the deceleration model for differently parameterized clothoids.

FIGS. 1a and 1b illustrate, by way of example route sections determined as a straight line and as an arc of a circle, with respective route points. The route points are arranged in the strip having the width Δ, the strip being illustrated by broken lines, and fall below respectively predeterminable distances from one another, in which case the distances can be different. Of course, the width Δ can also be different for different route sections. The solid line in the center of the respective route section represents the route section data and thus the geometry of the route section.

FIGS. 2a, b, c show by way of example a modeling of in each case three route points as a straight line, arc of circle, clothoid. The route points in FIG. 2a are arranged in a straight strip of predeterminable width, the strip being illustrated by broken lines, and fall below respectively predeterminable distances from one another, whereby the route section data are calculated as a corresponding straight line. The route points in FIG. 2b are arranged in a constantly curved strip of predeterminable width, the strip being illustrated by broken lines, and fall below respectively predeterminable distances from one another and the tangent to the, in the direction of travel, first one of the route points is essentially located on a direction vector of the vehicle, whereby the route section data are calculated as a corresponding arc of a circle. The route points in FIG. 2c are arranged in a progressively curved strip of predeterminable width, said strip being illustrated by broken lines, and fall below respectively predeterminable distances from one another, whereby the route section data are calculated as a corresponding clothoid.

FIG. 3 shows by way of example a route as a combined sequence of different route sections. A, in the direction of travel, first route section modeled as a straight line is followed by a route section with radius R modeled as an arc of a circle, and then by a further route section modeled as a straight line. This last route section has two intersections, i.e. points of intersection with routes—depicted by dotted lines—which do not lie on the traveling route of the vehicle.

In FIGS. 4 and 5, the vehicle speed is in each case plotted against the route covered. The hatched zones indicate in the respective deceleration regions the difference between the initial vehicle speed and the maximum speed in the respective route sections. The maximum speed is either set at the vehicle by an automatic speed regulating system, or a warning is issued to the driver of the vehicle if, in the case of manual control, he exceeds this speed at a respective spatial position.

FIG. 4 shows by way of example the deceleration model for different types of route sections. From the initially arbitrarily high speed on a straight line, the vehicle decelerates firstly linearly to the maximum permissible speed of the curve lying ahead by means of comfortable constant deceleration. The curve is subsequently traveled through at constant speed in accordance with the maximum permissible speed. A short acceleration phase is then followed by braking deceleration to a speed of 10% in order to safely pass an intersection. A further short acceleration phase is followed by renewed braking deceleration to a speed of 10 km/h, in order to safely pass a further intersection. The subsequent straight line can once again be traveled along at an arbitrarily high speed, for example a desired speed set by the driver.

FIG. 5 shows by way of example the deceleration model for differently parameterized clothoids. In this case, FIG. 5a shows the deceleration for a “gentle” clothoid, and FIG. 5b shows the deceleration for a “sharp” clothoid.

### PREFERRED EMBODIMENT OF THE INVENTION

In the preferred embodiment of the invention, a vehicle is provided which comprises not only a receiver for GPS signals but in addition a camera with downstream image processing and also a digital road map. The camera evaluates locally the route sections lying in front of the vehicle. The signals of the GPS receiver supply information about the current location of the vehicle. The digital road map supplies route points lying ahead on the traveling route of the vehicle. The road map is connected into a navigation system in which the journey destination has been input. As a result, the route to be traveled is already known. In order to obtain a particularly precise result with regard to route points lying ahead, the local results of the camera and the global knowledge of the digital road map are combined with one another. In this case, the accuracy of the method using GPS is dependent on the accuracy of the digital road map used. In this case, errors in the map can be corrected by the image evaluation of the camera (video system). Furthermore, the accuracy of the route points provided by the digital road map is supported by the route points provided by the video system. If the route points available from the video system are not accurate enough or cannot be obtained at all, for example because another vehicle is traveling in front of the vehicle, it is possible to have recourse to the route points of the digital road map. Both the camera with downstream image evaluation and the digital road map can supply both route points which indicate imminent curves and route points which indicate intersections lying ahead.

Using route points representing information about the route sections, the route sections are reconstructed step by step. There are three different types of route sections which are taken into account, namely straight lines, curve sections having a constant radius and curved sections have a progressive radius (clothoids). The route points are output serially. An analysis is performed to ascertain which of the route section models is currently just present. An iterative method is used for this purpose. Proceeding from the first two route points it is possible to define a theoretical straight line. A third route point is then added. It is once again determined whether a straight line is present. For this the three route points must be arranged in a strip of predeterminable width. The width is provided as a customary route width of 2 m. For this purpose, the model of a straight line is calculated anew using the least error squares method for these three points. If the strip having a width of 2 m is left, the hypothetical consideration as a straight line is terminated and an arc of circle equation is established, wherein the arc of the circle runs as well as possible through the three route points. In this case, the tangent to the first route point in the direction of travel must lie almost in a line with the direction vector of the vehicle. If this is not the case, the arc of circle model is rejected in favor of a clothoid model which is correspondingly adapted. If the model for the first three points is present, then the next route point is included. The corresponding equation of the model of an adapted straight line, of an adapted arc of a circle or of an adapted clothoid is established anew and confirmed or rejected with each new route point. If the model is rejected, then the last and the penultimate route point together with the new route point are established as a new model of the route section. If route points are provided whose positional deviation with respect to the model then current is only small, then the points can only indicate an intersection. For if a different direction had been followed at that moment, the route points would have exactly defined the region of the change in direction. This holds true for a current model of a straight line and also of a slight curvature, i.e. of a clothoid or of an arc of a circle with a large radius. If an intersection lying ahead is identified, the speed of the vehicle is reduced to a speed suitable for safely passing the intersection. Such a maximum permissible speed is 10 km/h. If the position of the intersection has been determined, the following information is available: relative distance between the vehicle and the intersection, the current speed of the vehicle and also the type of vehicle. Depending on the type of vehicle, the speed profile is calculated in accordance with the distance to the intersection. The speed change is fixed linearly, that is to say at a comfortable constant deceleration. If the speed of the vehicle is higher than the calculated speed, a corresponding warning light comes on or the vehicle is automatically braked.

To summarize, the invention results in a reduction of dangerous situations in traffic by means of a vehicle speed that is always adapted to the route section lying ahead. A safe approach to intersections lying ahead and a speed that is always lower than the maximum speed physically permissible in curves are made possible.

1. A method for determining the geometry of a route section, for determining a maximum permissible speed for a vehicle traveling along the route section, using route points representing the route section, comprising:
(a) checking to ascertain whether two adjacent route points fall below respectively predeterminable distances from one another and, in the affirmative, calculating route section data through the two adjacent route points and at least one further adjacent route point to be a) a straight line if the route points are arranged in a straight strip of predeterminable width, or b) an arc of a circle if the route points are arranged in a constantly curved strip of predeterminable width and the tangent to the, in the direction of travel, first one of the route points is essentially located on a direction vector of the vehicle, or c) a clothoid if the route points are arranged in a progressively curved strip of predeterminable width,
wherein the geometry of the route section in the region of said route points is in each case determined in the form of the calculated route section data, and
(b) determining a maximum permissible speed as a result of the geometry of the route section as determined in step (a).

2. The method as claimed in claim 1, wherein the route section data through the route points are calculated using the least error squares method.

3. The method as claimed in claim 1, wherein approximately two meters are fixed as predeterminable width for a strip in which the route points are arranged.

4. The method as claimed in claim 1, wherein route points are obtained as nodes and/or intermediate nodes (“shape points”) from a digital road map.

5. The method as claimed in claim 1, wherein route points and/or the current vehicle position are obtained using a position determining means at the vehicle.

6. The method as claimed in claim 1, wherein route points are obtained using image acquisition and evaluation.

7. The method as claimed in claim 1, wherein, for the case where a new route point is available, the geometry of the route section is retained when the distance between the new route point and the last route point falls below the respectively predeterminable distance and the new route point is arranged on the straight line or arc of a circle or clothoid determined by the at least three route points, otherwise a check is made to ascertain whether the new route point and also the last two route points in the direction of travel fall below respectively predeterminable distances from one another and in the affirmative route section data through said route points are calculated as a) straight line if the route points are arranged in a straight strip of predeterminable width, or b) arc of a circle if the route points are arranged in a constantly curved strip of predeterminable width and the tangent to the, in the direction of travel, first one of the route points is essentially located on a direction vector of the vehicle, or c) clothoid if the route points are arranged in a progressively curved strip of predeterminable width, wherein the geometry of the route section in the region of said route points is in each case determined in the form of the calculated route section data.

8. The method as claimed in claim 1, wherein, for the case where a new route point is available which exceeds the predeterminable distance, a straight line is assumed as route geometry.

9. The method as claimed in claim 1, wherein, if a new route point is available which is arranged outside the strip of predeterminable width, a check is made to ascertain whether the new route point is part of an intersection.

10. The method as claimed in claim 1, wherein a linear change in speed to the maximum permissible speed for the route section or intersection lying ahead is performed.

11. A computer program with program code means for carrying out all the steps of a method as claimed in claim 1 if the program is executed on a computer.

12. A computer program product with program code means which are stored on a computer-readable data carrier for carrying out the method as claimed in claim 1 if the computer program product is executed on a computer.

13. The method as claimed in claim 5, wherein route points and/or the current vehicle position are obtained using a GPS and/or GALILEO receiver.

14. The method as claimed in claim 6, wherein route points are obtained using video image acquisition and evaluation.

15. The method as claimed in claim 9 wherein said intersection is a vehicle-side setting of an intersection speed.
